(19) United States
(12) Patent Application Publication
(10) Pub. No.: US 2004/0071364 A1
(43) Pub. Date: Apr. 15, 2004

(54) Image processing apparatus, method and computer program for embedding watermark information into image data

(76) Inventors: Yukiko Yamazaki, Yokohama (JP); Takahiro Yagishita, Yokohama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/617,193

(22) Filed: Jul. 11, 2003

(30) Foreign Application Priority Data
Jul. 11, 2002 (JP) 2002-203065

(51) Int. Cl. G06K 9/36

(52) U.S. Cl. 382/276

(57) ABSTRACT

An image processing apparatus for embedding an electronic watermark into an original image including a background process device and a watermark embedding device. The background process device processes the background of the original image. The watermark embedding device embeds electronic watermark information into the original image after processing by the background process device.

### CROSS REFERRENCE TO RELATED APPLICATION

The present application claims priority under 35 USC §119 to Japanese Patent Application No. 2002-203065 filed on Jul. 11, 2002, the entire contents of which are herein incorporated by reference.

### BACKGROUND OF THE INVENTION

1. Field of the Invention

The present invention relates to technology for embedding additional information into data to provide copyright protection and alteration detection, and more particularly relates to an image processing apparatus and method, and a computer program product for embedding watermark information into image data of an original image to provide copyright protection and detection of illegal alteration of the original image data.

2. Discussion of the Background

In recent years, with the rapid progress of computers and networks, various types of information such as character data and image data have been used as digital data. Unfortunately, digital data can be easily copied and altered, which is a serious problem with respect to copyright protection.

Electronic watermarking is a technology used to provide copyright protection for digital data and to embed watermark information, such as the name of the copyright holder or an identifier of the purchaser, into digital data such that the embedded watermark information is imperceptible. Illegally copied data can then be easily identified by detecting such watermark information embedded in digital data using a specific device. Further, determining whether or not the digital data has been illegally altered can be detected by inspecting the embedded information extracted from the digital data for accuracy.

Generally, embedding electronic watermark information into data results in a trade-off between the volume of electronic watermark information that is embedded and the image quality of the resulting image data. For example, where the original data is a photograph with multi-valued pixels, a large volume of electronic watermark information can be easily embedded into the data while maintaining the image quality of the original data. However, where the original data is an image containing characters in which the characters are black and the background is white, pixels are almost binary and as such it is difficult to embed a large volume of electronic watermark information into the data while maintaining the image quality of the original data.

Japanese Laid-open patent publication No. 2001-309150 describes a technology based on a density pattern method for embedding electronic watermark information into binary image data. Binary image data is converted into a plurality of cells in which luminance information expressed by n-sets of numerals is converted into resolution information, and electronic watermark information is embedded into the binary image data as blocks of the cells. However, the volume of information that can be embedded into binary image data using this technique must be limited to maintain the original image quality of the binary image data.

There is thus an unmet need in the art for increasing the volume of information that can be embedded into image data while maintaining the quality of the image data.

### SUMMARY OF THE INVENTION

The present invention provides an image processing apparatus and method, and a computer program product for embedding watermark information into image data such that the volume of watermark information embedded into image data may be increased while maintaining the quality of the image data and facilitating detection of any alterations made to the image data.

Accordingly, one object of the present invention is to provide an image processing apparatus for embedding an electronic watermark into an original image. A background process device processes the background of the original image, and a watermark embedding device embeds electronic watermark information into the original image after processing by the background process device.

By processing the background of an original image, the volume of information that can be embedded into the data of the original image can be increased. Further, even where the background of the original image is white or in uniform density such that processing for detecting tampering or counterfeiting to the background is difficult, the processing to the background of the original image can still be facilitated.

Another object of the present invention is to provide an image processing apparatus in which the background process device may be configured to change the method of processing an original image according to the volume of electronic watermark information. Thus, where the volume of electronic watermark information to be embedded is relatively small, the image quality of the original image can be substantially maintained by suppressing the processing of the background to the minimum amount required.

Yet another object of the present invention is to provide an image processing apparatus in which the background process device may be configured to process the background in a non-cyclic pattern to increase protection, provided by the embedded watermark information, against tampering or counterfeiting, and to suppress deterioration of the quality of the image background due to the embedded information.

Another object of the present invention is to provide an image processing apparatus in which the background process device may be configured to process the background using only one of a plurality of color components of the original image generated by a color separation device that separates the original image into the plurality of color components.

Still another object of the present invention is to provide an image processing apparatus in which the background process device may be configured to process the entire background of the original image. Processing the entire background increases the volume of information that can be embedded while making it relatively hard to recognize the portion of the background where watermark information has been embedded. Also, by processing the entire background, the image quality of the original image can be visually improved.

Yet another object of the present invention is to provide an image processing apparatus in which the background process device may be configured to process a portion of the background such that where the original image includes a plurality of areas different from each other in properties, the portion of the background processed by the background process device may be the portion of the background corresponding to a text area of the plurality of areas, thereby increasing the volume of information that can be embedded into the background as a whole. Further, by processing the background with respect to a text area, the image quality of the original image can be visually improved.

Another object of the present invention is to provide an image processing apparatus that includes a background processing area selection device configured to select a portion of the background image to be processed. The background process device processes the portion of the background selected by the background processing area selection device. Embedding information into a portion of the background increases the volume of information that can be embedded while substantially maintaining the image quality of the original image.

Still another object of the present invention is to provide an image processing apparatus for embedding an electronic watermark into an original image that includes a background generation device configured to generate a background. A watermark embedding device embeds electronic watermark information into the generated background, and a combining device combines the background containing the embedded electronic watermark information with the original image.

The background containing embedded information can be prepared in advance. Accordingly, when processing several original images having the same characteristics, the overall process time can be decreased by preparing the background in advance. Further, where an original image contains only black characters, the background and the original image may be superimposed in the subsequent printing process instead of combining the original image and the background by preparing the background for the original image in black.

Yet another object of the present invention is to provide an image processing apparatus in which the background generation device may be configured to change the method of processing a background according to the volume of electronic watermark information.

Another object of the present invention is to provide an image processing apparatus for embedding an electronic watermark into an original image that includes a watermark embedding device configured to embed electronic watermark information into a predetermined background, and a combining device configured to combine the predetermined background containing the embedded electronic watermark information with the original image. The watermark information embedding device embeds the electronic watermark information into a background stored in memory in advance such that the process of generating the background is omitted and the overall process time for embedding watermark information is reduced.

Still another object of the present invention is to provide an image processing method for embedding an electronic watermark into an original image that includes processing the background of the original image and embedding electronic watermark information into the original image after the processing step. The processing step may change the method of processing the background relative to the volume of electronic watermark information.

Another object of the present invention is to provide an image processing method in which the processing step processes the background in a cyclic pattern.

Yet another object of the present invention is to provide an image processing method in which the processing step processes the background of the original image using only one of a plurality of color components of the original image.

Another object of the present invention is to provide an image processing method in which the processing step processes the entire background or alternatively a portion of the background of the original image. Where the original image includes a plurality of areas different from each other in properties, the portion of the background processed by the processing step is a portion of the background corresponding to a text area of the plurality of areas.

Still another object of the present invention is to provide an image processing method that includes selecting a portion of the background of the original image to be processed. The processing step processes the portion of the background selected by the selecting step.

Another object of the present invention is to provide an image processing method for embedding an electronic watermark into an original image that includes generating a background for the original image, embedding electronic watermark information into the generated background, and combining the background containing the embedded electronic watermark information with the original image. The generating step may change the method of generating a background relative to the volume of electronic watermark information. Further, the generating step may generate a background in a cyclic pattern.

Finally, another object of the present invention is to provide an image processing method for embedding an electronic watermark into an original image that includes embedding electronic watermark information into a predetermined background, and combining the predetermined background containing the embedded electronic watermark information with the original image.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram of an image processing apparatus according to an embodiment of the present invention;

FIG. 2 is a block diagram of an image processing apparatus according to another embodiment of the present invention;

FIG. 3A is an example of an original image containing characters;

FIG. 3B is an example of the original image after the background has been processed;

FIG. 4A is an example of another original image containing characters, an image and a graphic;

FIG. 4B is an example of the another original image after the background has been processed with the exception of the portions containing characters, an image and a graphic;

FIG. 5 is a block diagram of an image processing apparatus according to another embodiment of the present invention;

FIG. 6A is an example of another original image containing a table; and

FIG. 6B is an example of the still another original image after the background of a portion of the table has been processed.

### DETAILED DESCRIPTION OF THE PREFERRED EMBODIMENTS

Referring now to the drawings, wherein like reference numerals designate identical or corresponding parts throughout the several views, preferred embodiments of the present invention are described.

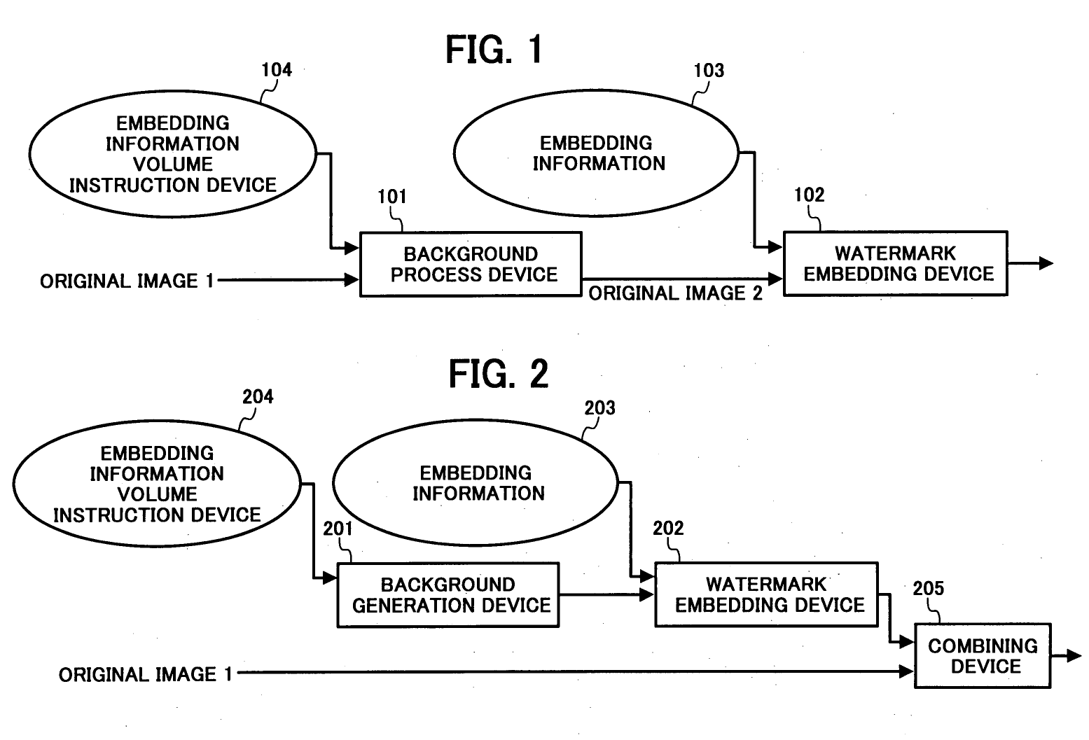

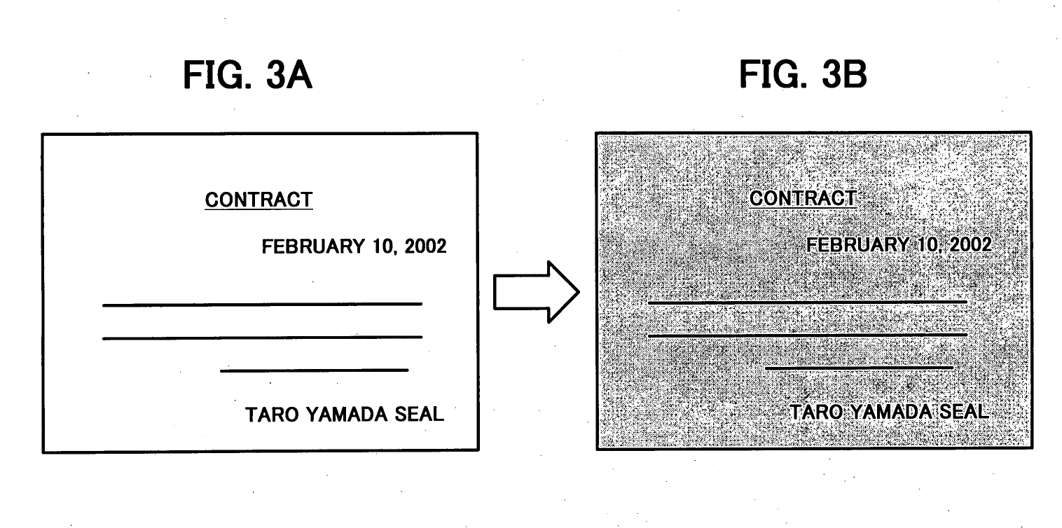

FIG. 1 illustrates a block diagram of an image processing apparatus according to an embodiment of the present invention. In this case, original image 1 contains characters only, as shown in FIG. 3A.

Background process device 101 inputs image data of the original image 1 and processes the background. The image data of the original image 1 may be read from a storage medium or supplied from an image scanning device, a digital camera, or other similar device. The background of the original image 1 must be processed such that the background will not decrease the legibility of characters of the original image 1. Further, the portion of the background where the electronic watermark information has been embedded must be difficult to recognized. The background of the original image 1 may be processed using a dither method, an error diffusion method, or other similar technique.

It is possible to process the background of the original image 1 using a dither method by controlling whether pixels are binary or multi-valued, the number of dither lines, the overall density, or other similar parameter. A multi-value dither method is superior to a binary dither method in processing the background because it provides stronger protection against tampering or counterfeiting, and a better background quality of the original image 1. A relatively large volume of information can be embedded into a background processed by the multi-valued dither method while maintaining the image quality of the background. Additionally, the volume of information that can be embedded into the processed background can be varied by the overall density level in dithering.

The legibility of the original image 1 should not be deteriorated as a result of processing the background of the original image 1 and thus the overall density level is preferably kept as low as possible. As such, where the processed background has a low density level, the portion of the background where information has been embedded might be recognized, and thus the volume of information embedded into the background must be decreased. Conversely, where the processed background has a high density level, the portion of the background where information has been embedded is harder to be recognized, and the volume of information embedded into the background may be increased.

Thus, where a dither method is used to embed electronic watermark information into the processed background, parameters such as the number of bits, the number of dither lines, and the overall density are closely related to the volume of information that can be embedded into the processed background to obtain satisfactory protection against tampering or counterfeiting while maintaining the image quality of the original image.

During processing of the background of the original image 1, an embedding information volume instruction device 104 conveys the volume of information to be embedded in the background to the background process device 101. The background process device 101 can thus process the background of the original image 1 relative to the volume of information to be embedded. As previously discussed, various parameters in processing the background of the original image 1 using a dither method are closely related to the volume of information that can be embedded to obtain satisfactory protection against tampering or counterfeiting while maintaining the image quality of the original image. By controlling these parameters, the background process device 102 processes the background such that the background is suitable for embedding the instructed volume of information while substantially maintaining the quality of the original image 1.

The background of the original image 1 after processing by the background process device 101 is preferably a non-cyclic pattern because it provides greater protection against tampering or counterfeiting. For example, a background with a uniform density that is processed by the background process device 101 using a dither method may result in a background having a cyclic pattern due to the repeated use of a predetermined dither table. To avoid a cyclic pattern, random numbers may be added to the uniform density of the background making the background uneven before applying the dither process. Alternatively, the dither table itself may be changed using random numbers. Other similar techniques may also be used to avoid a cyclic pattern.

Original image 1 after processing by the background process device 101 is shown as original image 2 in FIG. 3B. A watermark embedding device 102 then embeds embedding information 103, serving as a watermark, into the original image 2. Several embedding methods may be used to embed the embedding information 103 into the original image 2 including a picture element replacing method, or a frequency conversion method. The embedding information 103 may be a copyright indication, a generating date, data for detecting illegal alteration, or any other relevant information. The original image 2 in which the embedding information 103 has been embedded is the final original image.

Original image 1 may be either a black-and-white or color image. Where the original image 1 is a color image, processing the background and embedding information into the background may be applied for each color component space, such as RGB (red, green, black), YUV and YCbCr (luminance, chrominance difference), or CMYK (cyan, magenta, yellow, black). Further, with respect to a luminance and chrominance difference signal, it is possible to apply these processes to a luminance component only. Thus, by applying background processing and information embedding to only one color component or luminance component, the background processing and information embedding is less complex and performed in a relatively short period of time. Furthermore, the printing cost may be reduced when printing the original image 1 as a color image by making the background in one of the C, M, Y and K colors that is relatively inexpensive. Additionally, where the original image 1 contains characters in one color, a decrease in the legibility of the characters can be visually suppressed by processing the background in a different color.

FIG. 2 illustrates a block diagram of an image processing apparatus according to another embodiment of the present invention. A background generation device 201 generates a background for the original image 1. The volume of information to be embedded in the background is conveyed from an embedding information volume instruction device 204 to the background generation device 201. The background generation device 201 may adaptively change the method of generating a background. A watermark embedding device 202 then embeds embedding information 203 into the background. Finally, combining device 205 combines the background in which the embedding information 203 has been embedded with the original image 1.

A background containing embedded information may be prepared in advance. For instance, where there are several original images having the same characteristics, the overall process time can be decreased by preparing a background suitable for all of original images in advance. Also, where the original image 1 contains characters in only one of the C, M, Y or K colors, combining the embedded background with the original image 1 by the combining device 205 can be omitted and instead the background and the original image 1 may be superimposed in the subsequent printing process by preparing the background for the original image 1 in that color and embedding the embedding information 203 therein. Further, the process of generating the background for the original image 1 may be omitted reducing the overall process time by storing a background for one page or a few lines in advance in a storage device such as memory.

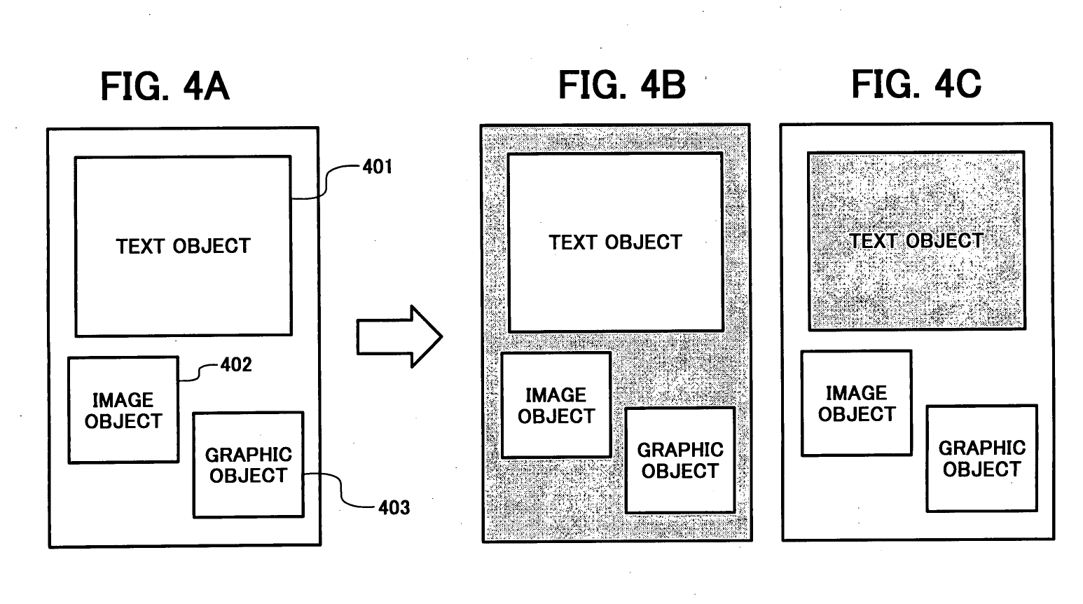

In another embodiment of the present invention, original image 1 contains characters, an image and a graphic. As shown in FIG. 4A, the original image 1 may be divided into a text object 401, an image object 402 and a graphic object 403 in a Post Script file used by a printer. As shown in FIG. 4B, processing of the background of the original image 1 may be applied to those portions of the background other than text object 401, image object 402 and graphic object 403. Alternatively, as shown in FIG. 4C, processing of the background may be applied only to the background portion of text object 401.

Where the original image 1 is bit-map image data, processing the background may be selectively applied individually to character, image or graphic areas by providing a device to detect and separate these areas from each other.

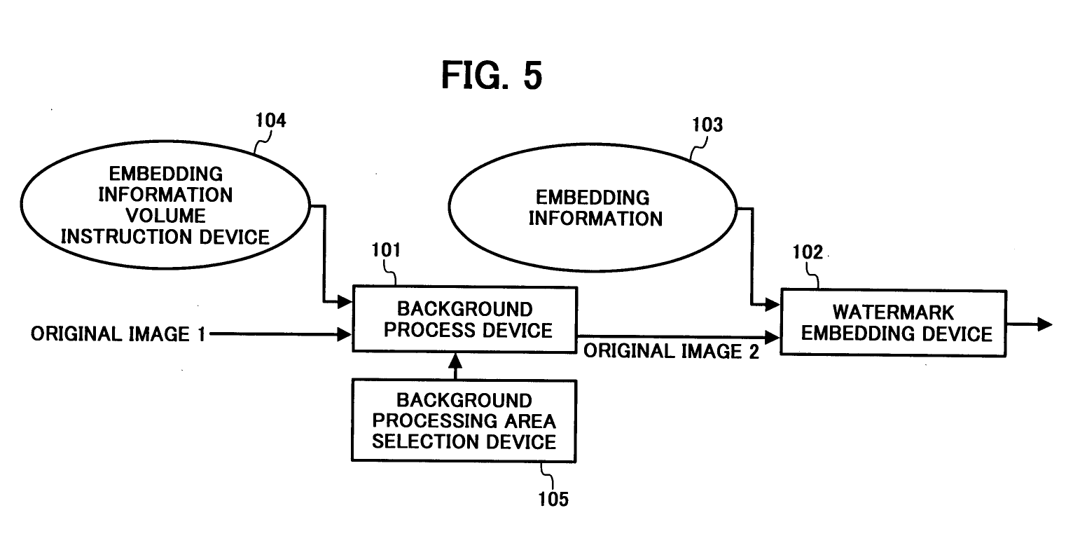

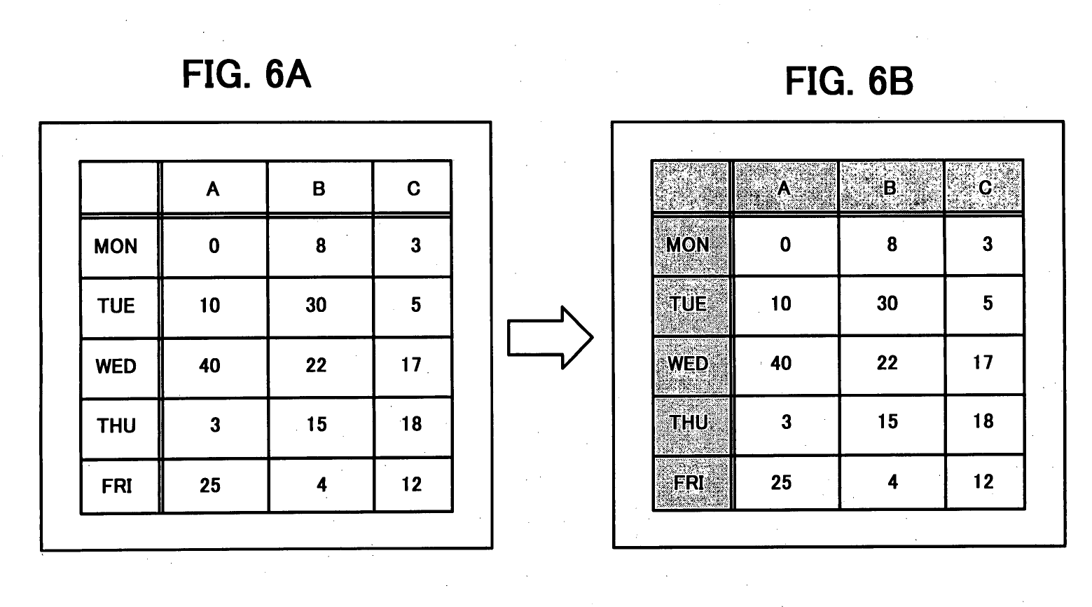

Processing the background and embedding information is made easier and performed in a relatively short period of time by processing only a portion of the background of the original image 1. Additionally, the overall process time may be decreased by processing only a portion of the background of the original image 1, rather than the entire background. FIG. 5 illustrates a block diagram of an image processing apparatus according to another embodiment of the present invention adapted to process a portion of the background of the original image 1. In this embodiment, a background processing area selection device 105 selects an area of the background to be processed and conveys the selected area to the background process device 101. The background processing area selection device 105 may be configured to display the original image 1 on a touch panel display device for user designation of the area of the background to be processed. Alternatively, the background processing area selection device 105 may be configured to automatically recognize the area of the background to be processed. For example, where the original image 1 contains characters, an image and a graphic, as shown in FIG. 4A, the background processing area selection device 105 may be configured to recognize the area of the text object 401 as the area of the background to be processed. Where the original image 1 contains a table, as shown in FIG. 6A, and the background process device 101 processes a portion of the table selected using the background processing area selection device 105, the table may have a decorative effect, as shown in FIG. 6B.

The processes and mechanisms set forth in the present description may be implemented using a conventional general purpose microprocessor programmed according to the teachings in the present specifications, as will be appreciated to those skilled in the relevant art. Appropriate software can be prepared based upon the teachings of the present disclosure, as will also be apparent to those skilled in the relevant arts.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, numerous modifications and variations of the present invention are possible in light of the above teachings. It is therefore to be understood that within the scope of the appended claims, the invention may be practiced otherwise than as specifically described herein.

1. An image processing apparatus, comprising:
a background process device configured to process a background of an original image; and
a watermark embedding device configured to embed electronic watermark information into the original image after having been processed by the background process device.

2. The image processing apparatus according to claim 1, wherein the background process device changes a method of processing the background according to a volume of the electronic watermark information.

3. The image processing apparatus according to claim 1, wherein the background process device processes the background to be in a non-cyclic pattern.

4. The image processing apparatus according to claim 1, wherein the background process device processes the background of the original image with respect to one of a plurality of color components of the original image generated by a color separation device separating the original image into the plurality of color components.

5. The image processing apparatus according to claim 1, wherein the background process device is configured to process the entire background of the original image.

6. The image processing apparatus according to claim 1, wherein the background process device is configured to process a portion of the background of the original image.

7. The image processing apparatus according to claim 6, wherein the portion of the background processed by the background process device corresponds to a text area of the plurality of areas, when the original image includes a plurality of areas different from each other in properties.

8. The image processing apparatus according to claim 1, further comprising:
a background processing area selection device configured to select a portion of the background of the original image to be processed,
wherein the background process device processes the portion of the background of the original image selected by the background processing area selection device.

9. An image processing apparatus, comprising:
a background generation device configured to generate a background for an original image;
a watermark embedding device configured to embed electronic watermark information into the generated background; and
a combining device configured to combine the background in which the electronic watermark information has been embedded with the original image.

10. The image processing apparatus according to claim 9, wherein the background generation device changes a method of generating the background according to a volume of the electronic watermark information.

11. The image processing apparatus according to claim 9, wherein the background generation device generates the background to be in a non-cyclic pattern.

12. An image processing apparatus, comprising:
a watermark embedding device configured to embed electronic watermark information into a predetermined background; and
a combining device configured to combine the predetermined background in which the electronic watermark information has been embedded with an original image.

13. An image processing apparatus, comprising:
a background process device configured to process a background of an original image; and
a watermark embedding device configured to embed electronic watermark information into the original image after having been processed by the background process device,
wherein the background process device changes a method of processing the background of the original image according to a volume of the electronic watermark information.

14. An image processing apparatus, comprising:
a background generation device configured to generate a background for an original image;
a watermark embedding device configured to embed electronic watermark information into the generated background; and
a combining device configured to combine the background in which the electronic watermark information has been embedded with the original image,
wherein the background generation device changes a method of generating the background of the original image according to a volume of the electronic watermark information.

15. An image processing method, comprising:
processing a background of an original image; and
embedding electronic watermark information into the original image after having been processed in the background thereof in the processing step.

16. The image processing method according to claim 15, wherein the processing step changes a method of processing the background of the original image according to a volume of the electronic watermark information.

17. The image processing method according to claim 15, wherein the processing step processes the background to be in a cyclic pattern.

18. The image processing method according to claim 15, wherein the processing step processes the background with respect to one of a plurality of color components of the original image.

19. The image processing method according to claim 15, wherein the processing step processes the entire background of the original image.

20. The image processing method according to claim 15, wherein the processing step processes a portion of the background of the original image.

21. The image processing method according to claim 20, wherein the portion of the background processed by the processing step corresponds to a text area of the plurality of areas, when the original image includes a plurality of areas different from each other in properties.

22. The image processing method according to claim 15, further comprising:
selecting a portion of the background of the original image to be processed,
wherein the processing step processes the portion of the background of the original image selected by the selecting step.

23. An image processing method, comprising:
generating a background for an original image;
embedding electronic watermark information into the background; and
combining the background after the embedding step with the original image.

24. The image processing method according to claim 23, wherein the generating step changes a method of generating the background of the original image according to a volume of the electronic watermark information.

25. The image processing method according to claim 23, wherein the generating step generates the background to be in a cyclic pattern.

26. An image processing method, comprising:
embedding electronic watermark information into a predetermined background; and
combining the predetermined background after the embedding step with an original image.

27. A computer program product for controlling an image processing apparatus, comprising:
a first computer code for processing a background of an original image; and
a second computer code for embedding electronic watermark information into the original image after the background has been processed.

28. The computer program product according to claim 27, wherein the first computer code changes a method of processing the background of the original image according to a volume of the electronic watermark information.

29. The computer program product according to claim 27, wherein the first computer code processes the background to be in a cyclic pattern.

30. The computer program product according to claim 27, wherein the first computer code processes the background with respect to one of a plurality of color components of the original image.

31. The computer program product according to claim 27, wherein the first computer code processes the entire background.

32. The computer program product according to claim 27, wherein the first computer code processes a portion of the background.

33. The computer program product according to claim 32, wherein the portion of the background processed by the first computer code corresponds to a text area of the plurality of areas, when the original image includes a plurality of areas different from each other in properties.

34. The computer program product according to claim 27, further comprising:
a third computer code for selecting a portion of the background of the original image to be processed,
wherein the first computer code processes the portion of the background of the original image selected by the third computer code.

35. The computer program product according to claim 27, wherein the computer program product is loadable into internal memory of a computer.

36. A computer program product for controlling an image processing apparatus, comprising:
a first computer code for generating a background for an original image;
a second computer code for embedding electronic watermark information into the background; and
a third computer code for combining the background after embedding by the second computer code with the original image.

37. The computer program product according to claim 36, wherein the first computer code changes a method of generating the background according to a volume of the electronic watermark information.

38. The computer program product according to claim 36, wherein the first computer code generates the background to be in a cyclic pattern.

39. The computer program product according to claim 36, wherein the first computer code changes a method of generating the background according to a volume of the electronic watermark information.

40. A computer program product for controlling an image processing apparatus, comprising:
a first computer code for embedding electronic watermark information into a predetermined background; and
a second computer code for combining the predetermined background after embedding by the first computer code with an original image.

41. An image processing apparatus, comprising:
processing means for processing a background of an original image; and
embedding means for embedding electronic watermark information into the original image after processing by the processing means.

42. The image processing apparatus according to claim 41, wherein the processing means changes a method of processing the background according to a volume of the electronic watermark information.

43. The image processing apparatus according to claim 41, wherein the processing means processes the background in a cyclic pattern.

44. The image processing apparatus according to claim 41, wherein the processing means processes the background with respect to one of a plurality of color components of the original image.

45. The image processing apparatus according to claim 41, wherein the processing means processes the entire background of the original image.

46. The image processing apparatus according to claim 41, wherein the processing means processes a portion of the background of the original image.

47. The image processing apparatus according to claim 46, wherein the original image includes a plurality of areas different from each other in properties, said portion of the background processed by the processing means corresponding to a text area of the plurality of areas.

48. The image processing apparatus according to claim 41, further comprising:
selecting means for selecting a portion of the background of the original image to be processed,
wherein the processing means processes the portion of the background selected by the selecting means.

49. An image processing apparatus, comprising:
generating means for generating a background for an original image;
embedding means for embedding electronic watermark information into the background; and
combining means for combining the background after embedding by the embedding means with the original image.

50. The image processing apparatus according to claim 49, wherein the generating means changes a method of generating the background according to a volume of the electronic watermark information.

51. The image processing apparatus according to claim 49, wherein the generating means generates the background in a cyclic pattern.

52. An image processing apparatus, comprising:
embedding means for embedding electronic watermark information into a predetermined background; and
combining means for combining the predetermined background after embedding by the embedding means with an original image.

53. An image processing apparatus, comprising:
processing means for processing a background of an original image; and
embedding means for embedding electronic watermark information into the original image after processing by the processing means,
wherein the processing means changes a method of processing the background according to a volume of the electronic watermark information.

54. An image processing apparatus, comprising:
generating means for generating a background for an original image;
embedding means for embedding electronic watermark information into the background; and
combining means for combining the background after embedding by the embedding means with the original image,
wherein the generating means changes a method of generating the background according to a volume of the electronic watermark information.
